(19) United States
(12) Patent Application Publication
(10) Pub. No.: US 2017/0293944 A1
(43) Pub. Date: Oct. 12, 2017

(54) Identifying Temporal and Spatial Optimizations

(71) Applicant: Optmyzr Inc., Foster City, CA (US)

(72) Inventors: Manas Garg, Hyderabad (IN); Geetanjali Tyagi, Hyderabad (IN); Frederick Vallaeys, Palo Alto, CA (US)

(21) Appl. No.: 15/097,173

(22) Filed: Apr. 12, 2016

(51) Int. Cl. G06Q 30/02; G06F 17/30

(52) U.S. Cl. CPC G06Q 30/0275; G06Q 30/0277; G06F 17/30864

(57) ABSTRACT

In one embodiment, a method includes accessing data about past performance of an online advertising campaign with respect to one or more online-advertising metrics; generating a first visualization of the past performance of the online advertising campaign as a function of an independent variable and a second visualization of past bid adjustments for online advertisements in the online advertising campaign corresponding to the past performance of the online advertising campaign as a function of the independent variable; receiving user input from a user specifying future bid adjustments for online advertisements in the online advertising campaign relative to the past bid adjustments as a function of the independent variable; and applying the user input to future bid adjustments for online advertisements in the online advertising campaign relative to the past bid adjustments as a function of the independent variable.

### BACKGROUND

An online-advertising service like Google AdWords enables advertisers to compete to display advertising copy to users based on predetermined keywords (usually set by the advertisers) that link the copy to the content of web pages (which may include search results) shown to users.

Web pages from Google and other websites allow the online advertising service to select and display the advertising copy, and advertisers pay when users divert their browsing to seek more information about the copy displayed. For example, with the online-advertising service, an advertiser may create an advertisement that indicates what the advertiser offers. The advertiser may then choose one or more keywords that will cause the advertisement to be shown in Google or other search results. The advertiser may set a daily or other budget for displays of the advertisement. When search terms entered by a user for a Google or other web search match the keywords associated with the advertisement, the advertisement may appear above or next to search results shown to the user. The user may then select the advertisement and be directed to a website of the advertiser. The online-advertising service may include features that enable advertisers to target by website type, audience type, or remarketing, helping them to reach more relevant users and more relevant web pages. The online-advertising service may also provide analytic tools to advertisers. Such tools may, for example, track and show an advertiser how many people noticed advertising copy of the advertiser and what percentage click-through to a website of the advertiser or otherwise contact the advertiser.

### SUMMARY OF PARTICULAR EMBODIMENTS

An advertising-analytics service may provide one or more visualizations of the past performance of an online advertising campaign. The visualizations may be time-based or geography based. In particular embodiments, the visualizations may be interactive. A subscriber of the advertising-analytics service may view a visualization of the past performance of one or more of her online advertising campaigns. In a time-based visualization, the advertising-analytics campaign may display one or more metrics in a graph, the metrics being specified by the subscriber. Such a visualization may provide the subscriber with insights that would be difficult to discern without the visualization. Thus, the subscriber may more readily recognize bid modifications to make during certain times of the day, week, or month. The advertising analytics service may further display an interactive visualization directly below the graph, such that the interactive visualization and the graph share the same x-axis.

### BRIEF DESCRIPTION OF THE DRAWINGS

FIG. 1 illustrates an example advertising-analytics service in an example network environment.

FIG. 2 illustrates an example time-based visualization of an online advertising campaign provided by an advertising-analytics service.

FIG. 3 illustrates another example time-based visualization of an online advertising campaign provided by an advertising-analytics service.

FIG. 4 illustrates an example geography-based visualization of an online advertising campaign provided by an advertising-analytics service.

FIG. 5 illustrates another example geography-based visualization of an online advertising campaign provided by an advertising-analytics service.

FIG. 6 illustrates an example method for providing visualizations of an online advertising campaign.

FIG. 7 illustrates an example computer system.

### DESCRIPTION OF EXAMPLE EMBODIMENTS

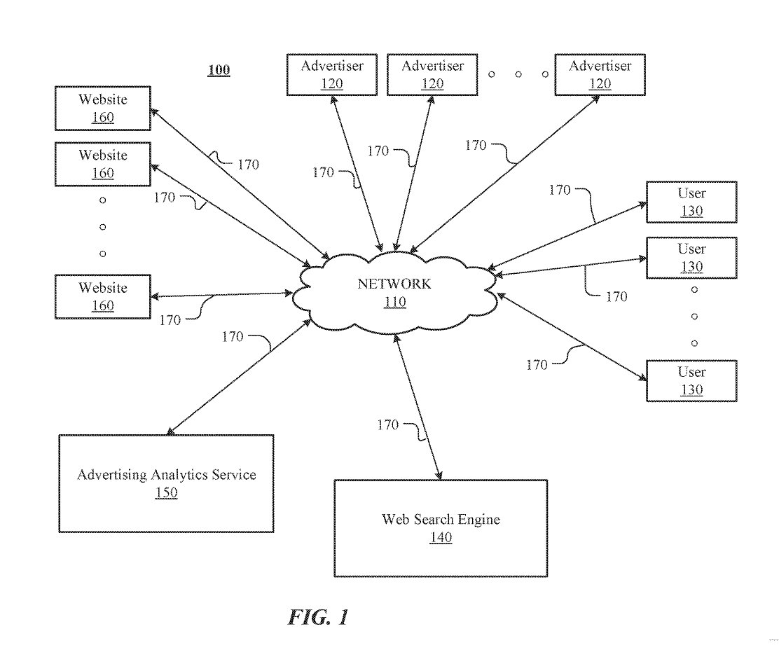

FIG. 1 illustrates an example advertising-analytics service in an example network environment 100. Network environment 100 includes one or more advertisers 120, one or more users 130, a web search engine 140 (e.g., GOOGLE), advertising analytics-service 150, and one or more websites 160 connected to each other by network 110. Although FIG. 1 illustrates network environment 100 as including a particular number of particular entities in m a particular arrangement, this disclosure contemplates any suitable number of any suitable entities in any suitable arrangement. As an example and not by way of limitation, two or more of advertisers 120, users 130, web search engines 140, advertising-analytics service 150 and websites 160 may be connected to each other directly, bypassing network 110. As another example, two or more of advertisers 120, users 130, web search engines 140, advertising-analytics service 150 and websites 160 may be physically or logically co-located with each other in whole or in part.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular-technology-based network, or a combination of two or more of these. Network 110 may include one or more networks 110.

One or more links 170 couple advertisers 120, users 130, web search engines 140, advertising-analytics service 150, and websites 160 to network 110. This disclosure contemplates any suitable links 170. In particular embodiments, one or more links 170 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 170 each include an ad hoc network, an intranet, an extranet, a VPN, a LAN, a WLAN, a WAN, a WWAN, a MAN, a portion of the Internet, a portion of the PSTN, a cellular-technology-based network, a satellite-communications-based network, another link 170, or a combination of two or more such links 170. Links 170 need not necessarily be the same throughout network environment 100. One or more first links 170 may differ in one or more respects from one or more second links 170.

A user 130 may be an individual (human user), an entity (e.g., an enterprise, business, or third-party application), or a group (e.g., of individuals or entities) that uses the Internet. User 130 may browse the Internet and visit websites either by entering a uniform resource locator (URL) into an Internet browser (e.g., CHROME), or by entering a search query into a web search engine. If user 130 enters a search query into a web search engine 140, the web search engine 140 may search the Internet for web pages (hosted by websites 160) that are relevant to the search query. Web search engine 140 may then display a search results page comprising a list of organic and non-organic search results. The organic search results may be references that the web search engine has identified as being particularly relevant to the search query entered by user 130. The non-organic search results may be paid advertisements or sponsored listings that an online advertising service (e.g., GOOGLE ADWORDS) has identified after calculating the “Adrank” of several paid advertisements. The Adrank of a particular advertisement determines its position on the search results page. It is calculated by multiplying the bid amount (often referred to as a “maximum cost per click” (max. CPC)) with the advertisement's keyword Quality Score. Thus, Adrank=max CPC×Qualityscore. An advertisement's Quality Score depends on several factors, including keywords associated with the advertisement, the click-through rate (CTR) for various components of the advertisement or account (e.g., CTR of keywords, CTR of the ads and keywords for the account, CTR of a specific URL), the quality of a landing page associated with the advertisement, the relevancy of the keywords to the search query, geographic performance, and the type of device on which the search was performed. Thus, Adrank=max CPC×Qualityscore. Advertisements with a higher Adrank are placed higher on the search results page. Thus, advertisers 120 may wish to optimize their Adrank in order to receive a higher ad position and ultimately maximize conversions. A conversion may occur when a user 130 switches from being a site visitor into a paying customer.

The online advertising service may be operated by web search engine 140. Advertiser 120 may have an online account with the online advertising service to place non-organic search results on the search results page. In addition to placing advertisements based on Adrank, the online advertising service may additionally provide data to advertiser 120 so that advertiser 120 may make better advertising decisions. Such advertising decisions may comprise selecting more relevant keywords, changing bid amounts for particular keywords, changing bid amounts based on the day of the week or the time of the day, changing bid amounts based on the geographic region of a search query, among others. Often, the data provided by the online advertising service may be complex or disorganized. Advertising-analytics service 150 may aid in the analysis of such advertising information by providing tools to advertisers 120 who subscribe to advertising-analytics service 150. Herein, such advertisers 120 may be referred to as subscribers. The tools provided to the subscribers by advertising-analytics service 150 may help the subscribers interpret the advertising information by providing visualizations of various metrics. The tools may also provide one or more recommendations for optimizations a subscriber may make to its advertising strategy. In particular embodiments, the advertising-analytics service 150 may provide one or more interfaces between the web search engine 140 and the subscriber. This interface may be provided to make it easier for subscribers to interact with the advertising information and make changes to their account with the online advertising service. These tools, recommendations, and interfaces will be discussed in more detail below. Example metrics that advertising-analytics service 150 may provide to a subscriber are discussed in the following table:

TABLE 1
Example Metrics

| Metric | Description |
|---|---|
| number of | The number of impressions may be number of single |
| impressions | displays of a non-organic search result on a search |
| | results page. |
| average cost | The average cost per click may be the average amount |
| per click | charged to advertiser 120 every time a user clicks on a |
| | non-organic search result. |
| number of | The number of clicks may be the number of times a non- |
| clicks | organic search result has been clicked on by users 130. |
| click-through | The click-through rate (CTR) may be the proportion of |
| rate | users who click on a particular non-organic search result |
| | compared to the total number of users who view that |
| | non-organic search result. |
| cost | The cost may be the total cost of a particular non-organic |
| | search result, or the cost of achieving a conversion. |
| average | The average position may be the average order in which a |
| position | particular non-organic search result appears on a search |
| | results page in relation to other non-organic search results. |
| | A position of “1” means that the non-organic search result |
| | is the first on the page. |
| impression | Impression share may be the number of actual impressions |
| share | divided the number of eligible impressions. An advertise- |
| | ment is eligible for an impression if at least some of its |
| | keywords match at least some of the n-grams of a search |
| | query. |
| conversion | Conversion value may be a set amount of money for a |
| value | given conversion. For example, a purchase conversion |
| | may be worth 625. As another example, a newsletter |
| | signup may be worth 65. |
| conversion | Conversion value/cost may be the ratio of the value |
| value/ | received from a conversion to the cost of achieving |
| cost | that conversion. |
| conversion | Conversion value per click may be the value of a conver- |
| value | sion divided by the number of clicks a non-organic |
| per click | search result achieved. |
| converted | Converted clicks may be the number of clicks that convert |
| clicks | within an advertisers chosen conversion window. If a user |
| | makes two separate purchases after clicking on an |
| | advertisement, the user will register as one conversion |
| | click. |
| cost per | Cost per conversion click may be the cost of an advertise- |
| conversion | ment divided by the number of converted clicks. This may |
| click | also be referred to as “cost per acquisition” |
| conversion | Conversion rate may be the total number of conversions |
| rate | divided by the total number of ad clicks that can be |
| | tracked to a conversion during the same time period. |

Although Table 1 describes particular metrics that advertising-analytics service 150 may provide to a subscriber, this disclosure contemplates any suitable metrics that advertising-analytics service 150 may provide to a subscriber. Moreover, although Table 1 provides particular definitions of particular metrics that advertising-analytics service 150 may provide to a subscriber, this disclosure contemplates any suitable definitions of any suitable metrics that advertising-analytics service 150 may provide to a subscriber.

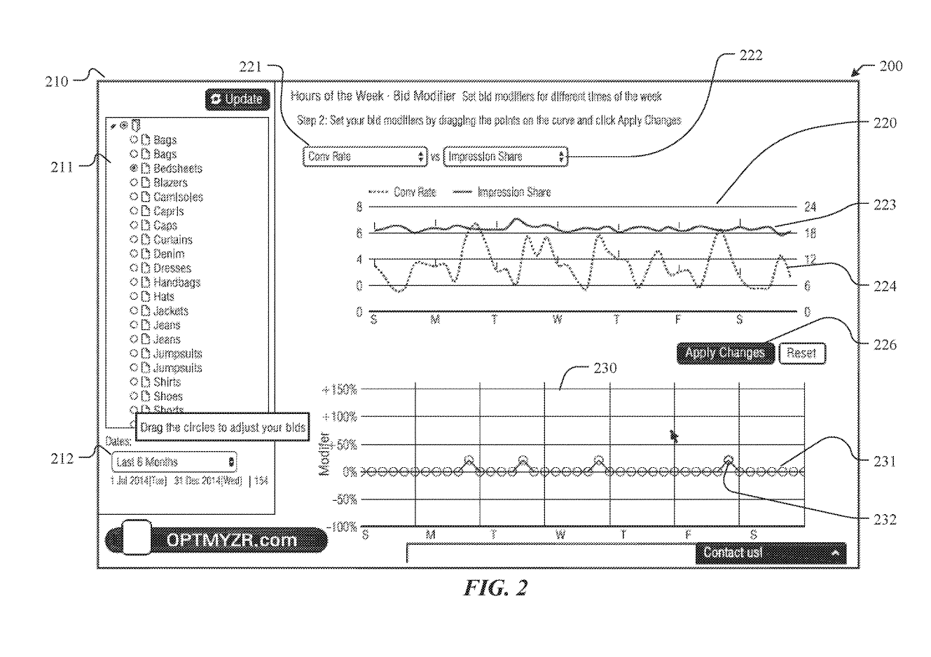

FIG. 2 illustrates an example time-based visualization 200 of an online advertising campaign provided by an advertising-analytics service 150. Time-based visualization 200 may include campaign toolbar 210, metrics visualization 220, and bid-modifier graph 230. In particular embodiments, metrics visualization 220 may be time-based. A time-based metrics visualization may be understood to mean a visualization that illustrates how a particular online advertising campaign has performed over a specified period of time. It may also apply a level of aggregation over a specified period of time to show performance by hour of day, hour of week, day of the week, and the like. A subscriber of advertising-analytics service 150 may use an Internet browser to navigate to time-based visualization 200. The subscriber may select a campaign radio button from the campaign selection panel 211 to display the past performance of a particular campaign. As an example and not by way of limitation, the subscriber may select the bedsheets radio button and may then be presented with the past performance of the bedsheets online advertising campaign on metrics visualization 220. Although FIG. 2 illustrates particular online advertising campaigns, this disclosure this disclosure contemplates any suitable online advertising campaigns covering any suitable products or services. Moreover, although FIG. 2 illustrates a particular UI element for selecting an online advertising campaign, this disclosure contemplates any suitable UI element or elements for selecting online advertising campaigns. In addition to selecting a particular campaign, the subscriber may also select a date range in date-range selector 212. The range of dates may be any suitable range of dates. For example, the date range may vary from the last day or week, to the past six months, year, or longer. Alternatively, the date range may span specified dates in the past. For example, the subscriber may specify that the date range to be displayed is Nov. 1, 2014 through Jan. 1, 2015. This may be beneficial because the subscriber may wish to see how a particular online advertising campaign performed over the previous holiday season, and make bid adjustments in preparation for an upcoming holiday season. A bid adjustment may be a percentage increase or decrease applied to a campaign's, ad group's, or keyword's cost-per-click bid in specific situations (e.g., time of day/week, particular geographic location, etc.).

In particular embodiments, the subscriber may select a first metric in first metric selector 221 and may select a second metric in second metric selector 222. The metrics in first metric selector 221 and in second metric selector 222 may be any suitable metrics for an online advertising campaign. Such metrics may include but are not limited to number of impressions, average cost per click, number of clicks, click-through rate, cost, average position, impression share, conversion value, conversion value/cost, conversion value per click, converted clicks, cost per conversion click, and conversion rate. Example descriptions of these example online advertising metrics are provided in Table 1. As an example and not by way of limitation, the subscriber may select conversion rate as the first metric and impression share as the second metric. Impression share may be represented by impression share line 223 on metrics visualization 220. Conversion rate may be represented by conversion rate line 224 on metrics visualization 220. The numbers appearing on the left side of metrics visualization 220 may correspond to the metric appearing in first metric selector 221. The numbers appearing on the right side of metrics visualization 220 may correspond to the metric appearing in second metric selector 222. For example, and not by way of limitation, the numbers 0, 4, 6, and 8 that appear on the left side of metrics visualization 220 may correspond to the conversion rate for the bedsheets online advertising campaign, and the numbers 0, 6, 12, 18, and 24 that appear on the right side of metrics visualization 220 may correspond to the impression share for the bedsheets online advertising campaign.

In particular embodiments, such a visualization may provide the subscriber with insights that would be difficult to discern without the visualization. As an example and not by way of limitation, the subscriber may observe that while impression share line 223 remains relatively stable, conversion rate line 224 fluctuates. The subscriber may notice that conversion rate “spikes” (e.g., increases dramatically) at certain times of the week. For example, conversion rate may spike on Monday afternoons, Wednesday afternoons, and Saturday mornings. During times when the conversion rate is high, it may be desirable to increase impression share, because those are the times when each impression is most valuable. Based on the visualization, the subscriber may more readily appreciate that if she increases her impression share during these conversion rate spikes, her conversion rate during these times may rise even higher. As Adrank=max CPC×Qualityscore, it may be desirable for the subscriber to increase her “maxCPC” (e.g., bid amount), for the specific times in which the conversion rate spikes. On the other hand, the subscriber may notice that conversion rate drops at certain times of the week. This may prompt the subscriber to decrease her bid amounts accordingly, because these impressions are the least valuable, so the subscriber may want to pay less for these impressions.

In particular embodiments, advertising-analytics service 150 may provide a second visualization to aid in adjusting bid amounts for specific times in a day or week. In particular embodiments, the second visualization may be interactive. As an example and not by way of limitation, the second visualization may be bid modifying visualization 230. Bid modifying visualization 230 may be displayed directly below metrics visualization 220, so that the bid modifying visualization 230 and metrics visualization 220 share the same x-axis. Bid modifying visualization 230 may include a bid modifying line 231, that is originally displayed along the 0% mark according to the numbers on the left side of bid modifying visualization 230. Although the individual bid modifiers are illustrated as circles in FIG. 2, individual bid modifiers may be illustrated as any suitable portrayal of a bid modifying element. Examples may include a line, dots, points, a histogram, etc. In particular embodiments, the subscriber may adjust an individual bid modifier 232 by selecting individual bid modifier 232 (e.g., by clicking, tapping, or otherwise selecting) and dragging it up or down. The left side of bid modifier graph 230 may display a relative amount of increase or decrease in a bid amount. As an example and not by way of limitation, dragging individual bid modifier up to the 50% line may indicate that the subscriber wishes to increase the bid amount for bedsheets on Friday night by 50% on a weekly basis. Once the subscriber has made the desired changes to one or more bid amounts, the subscriber may apply these modifications by selecting apply changes button 226. Each individual bid modifier 232 may correspond with a specific time in the metrics visualization 220. An adjustment up or down of an individual bid modifier 232 may cause the bid amount for the corresponding time to be adjusted up or down, depending on how the subscriber adjusted the individual bid modifier 232. The specified changes may then be applied to the subscriber's online advertising campaign by advertising-analytics service 150 without any additional input from the subscriber.

As an example and not by way of limitation, an advertiser Becky may subscribe to advertising-analytics service 150 to improve her online advertising campaign for dresses she is selling online. Becky may use a web browser to navigate to time-based visualization 200, and select to view the past performance of the dresses campaign by selecting an appropriate radio button on campaign toolbar 110. She may select to view the previous six months of campaign performance for her dresses by selecting the appropriate time frame in date-range selector 212. Becky may also select at least two metrics to compare in first metric selector 221 and second metric selector 222. Becky may select conversion value per click as the first metric and average position as the second metric. By viewing these two metrics' past performance on metric visualization 220, Becky may notice that her conversion value per click spikes when average position is between 4 and 6 at certain times during the week. This may alert Becky to the fact that her advertising budget is most effective when her bid amounts are set to achieve an average position of 4, 5, or 6 (as opposed to 1, 2, or 3, which are more expensive). Thus, Becky may choose to adjust her bid amounts accordingly. To adjust her bid amounts, Becky may select and drag individual bid modifiers 232 to a desirable level. When Becky is satisfied with her bid adjustments, she may select the “apply changes” button and the advertising-analytics service may automatically update her online advertising campaign for dresses.

A bid adjustment may be a percentage increase or decrease applied to a campaign's, ad group's, or keyword's cost-per-click bid in specific situations (e.g., time of day/week, particular geographic location, etc.). As an example and not by way of limitation For example, assume a subscriber Becky places a starting bid of $1. Later on, she may adjust the bid up 50% on Tuesdays and Thursdays at 3 pm. This adjustment to the original bid may be a bid adjustment. The resulting bid for those specific times may be $1.50. Then the next week, Becky may increase her bids on Tuesdays and Thursdays at 3 pm up another 25%. This is another bid adjustment on the previous week's bid adjustment.

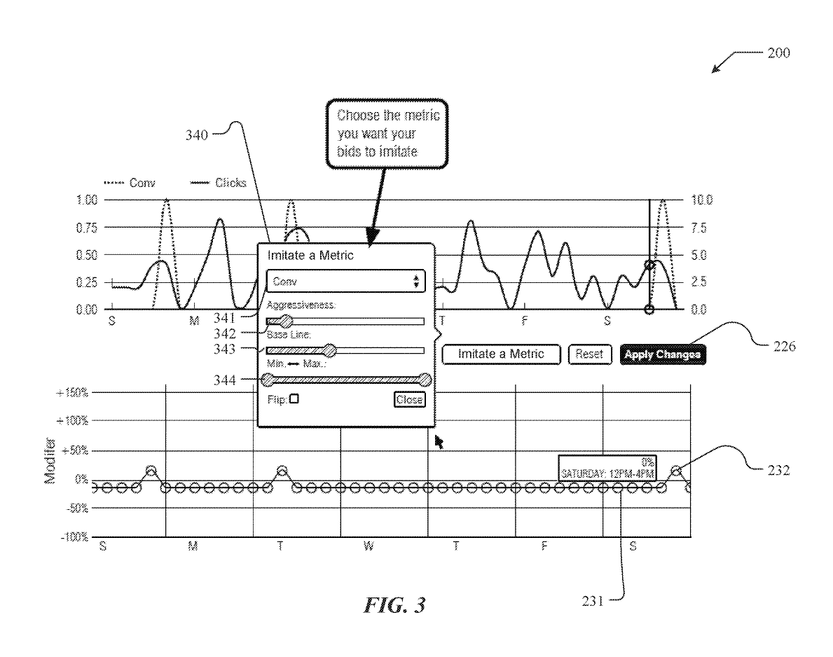

FIG. 3 illustrates another example time-based visualization of an online advertising campaign provided by an advertising-analytics service. Time-based visualization 200 may comprise the same components as those illustrated in FIG. 2, but with an additional dialogue box 340. Dialogue box 340 may be displayed automatically, or may be displayed in response to the subscriber clicking a button that says “Imitate a metric” or something similar. Dialogue box 340 may aid in the efficient modification of bid amounts and may imitate one or more metrics of an online advertising campaign. Dialogue box 340 may comprise a metric selector 341, an aggressiveness indicator 342, a baseline indicator 343, and a min/max indicator 344. A subscriber may interact with dialogue box 340 by selecting a button that appears on time-based visualization 200 that says “imitate a metric” or some similar phrase. Metric selector 341 may comprise the two metrics previously selected by the subscriber, all available metrics, or a subset of metrics. The subscriber may select the desired metric, and then adjust aggressiveness indicator 342, baseline indicator 343, and min/max indicator 344, as desired. Alternatively, advertising-analytics service may automatically determine default settings for dialogue box 340. The subscriber may simply accept the default settings, or may adjust the default settings by selecting and dragging any of the settings to a desired position.

Min/max indicator 344 may either set a minimum and maximum bid amount in dollars or another suitable currency, or may set a minimum and maximum percentage to raise or decrease current bid amounts. As an example and not by way of limitation, min/max indicator 344 may set a minimum percentage of 10% and a maximum percentage of 200%. This may indicate that a bid amount of 610 may not be adjusted lower than 61 or greater than 620, no matter how aggressive aggressiveness indicator 342 is set. Once the subscriber has made the desired changes to dialogue box 340, the subscriber may apply these modifications by selecting apply changes button 226. The specified changes may then be applied to the subscriber's online advertising campaign by advertising-analytics service 150 without any additional input from the subscriber. Alternatively, the subscriber may simply select a button that says “imitate a metric” or a similar phrase and then select apply changes button 226 and the changes may be made automatically.

In particular embodiments, advertising-analytics service 150 may normalize the selected metric that is to be imitated so that the highest values correspond to the highest possible bid adjustment and the lowest values correspond to the lowest possible bid adjustments that can be set in the advertising system. Advertising-analytics service 150 may also scale the resulting curve to make small bid adjustments rather than big dramatic bid adjustments. It may clip the curve to stay within the subscriber-selected bounds of how much the subscriber want the minimum and maximum bid adjustments to be. The curve can be shifted up or down on the y-axis to apply a baseline bid adjustment that could be smaller or greater than 0. The algorithm may default to a conservative adjustment of bids but subscribers may make it more aggressive using the settings that impact the scaling, clipping and shifting described above.

As an example and not by way of limitation, a subscriber Becky may use a web browser to navigate to time-based visualization 200, and select to view the past performance of the dresses campaign by selecting an appropriate radio button on campaign toolbar 110. She may select to view the previous six months of campaign performance for her dresses by selecting the appropriate time frame in date-range selector 212. Becky may also select at least two metrics to compare in first metric selector 221 and second metric selector 222. Becky may select impression share as the first metric and conversion rate as the second metric. Advertising-analytics service 150 may automatically calculate the optimal bid amounts for Becky. The calculation may be performed by one or more servers executing software specifically written for this purpose. The software may search for spikes in conversion rate on metric visualization graph 220 and then automatically adjust the bid amounts in bid modifying visualization 230. Advertising-analytics service 150 may then display these bid adjustments for Becky to view. Alternatively, advertising-analytics service 150 may display the bid adjustments only after Becky has selected the button saying “imitate a metric.” In response to this selection, the advertising-analytics service 150 may display dialogue box 340, comprising metric selector 341, aggressiveness indicator 342, baseline indicator 343, and min/max indicator 344. Becky may adjust these indicators as she desires. If Becky increases the aggressiveness of the aggressiveness indicator 342, advertising-analytics service 150 may simultaneously increase the bid amounts it automatically selected to increase. Advertising-analytics service 150 may also simultaneously display the individual bid modifiers 232 moving up or down the screen as an animation display corresponding to how aggressive Becky selects for the aggressiveness indicator 341. When Becky is satisfied with her adjustments in dialogue box 3440, she may close dialogue box 340 and select the “apply changes” button. The advertising-analytics service may then automatically update her online advertising campaign for dresses.

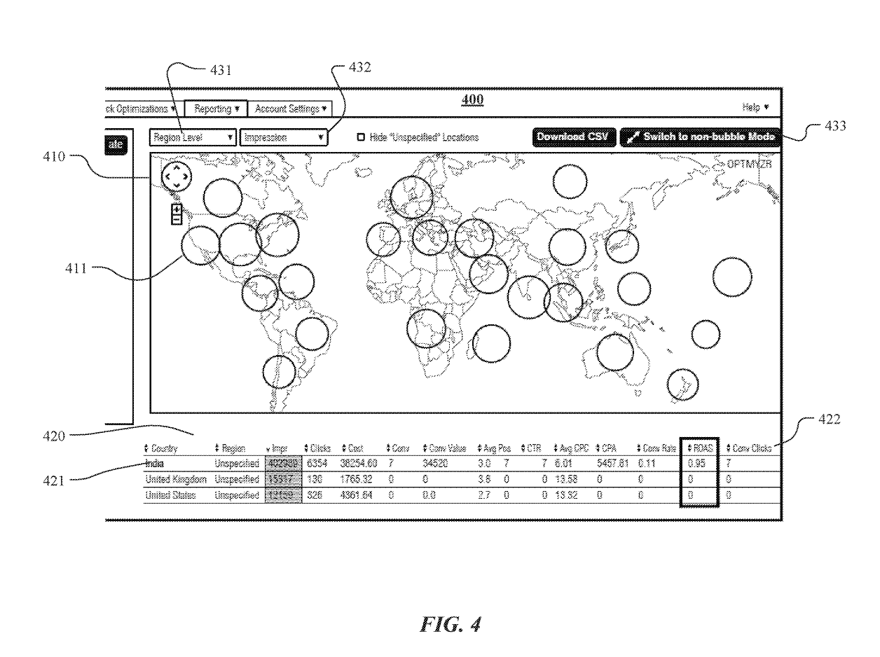

FIG. 4 illustrates an example geography-based visualization 400 of an online advertising campaign provided by an advertising-analytics service. Geography-based visualization 400 may include an area selector 431, a metric selector 432, a map 410, and a table 420. Map 410 may include one or more geography bubbles 411. Table 420 may include one or more regions 421 and one or more metrics 422. Metrics 422 associated with the online advertising campaign. The values under each metric may be the data associated with each metric for a particular region 421. In particular embodiments, regions 421 may be countries. Alternatively, regions 421 may be states within a single country, smaller regions within a state/country, or any other suitable region. Geography bubbles 411 may indicate the value of whichever metric the subscriber has selected. Geography bubbles 411 may be associated with the geographic area that they cover on map 410. Geography bubbles 411 may be sized based on the value of the metric selected in metric selector 432. As an example and not by way of limitation, a subscriber may select conversion rate in metric selector 432. A geography bubble 411 over Indiana may be larger than a geography bubble 411 over Florida. This may indicate that the conversion rate in Indiana is higher than the conversion rate in Florida. In particular embodiments, map 410 may include multiple metric selectors and multiple types of geography bubbles, each type associated with a particular metric. Each type of geography bubbles may have distinguishing characteristics (e.g., each geography bubble type may have its own unique color, pattern, grayscale, shape, etc.). As an example and not by way of limitation, the impression share metric may be illustrated with blue geography bubbles and the conversion rate metric may be associated with green geography bubbles. This may allow a subscriber to readily identify geographic areas with high conversion rates compared to impression share. This may be possible because these areas may have large green geography bubbles relative to red geography bubbles. This disclosure contemplates any suitable distinguishing features for geography bubbles 411 (e.g., color, pattern, shapes, shading). In particular embodiments, map 410 may additionally or alternatively include a campaign selector panel similar to campaign selector panel 211, a segmentation selector, in which the data may be segmented by network (e.g., GOOGLE, BING, etc.), or by device (e.g., desktop, tablet, mobile, etc.), and a date range selector, similar to date range selector 212. Note that the segmentation selector may enable the subscriber to select more than one segment (e.g., to the performance of the campaign on mobile and desktop). The subscriber may zoom in or out on map 410 and table 420 may be automatically updated to only display data of geography bubbles 411 that are visible. The subscriber may select a region level in region level selector 431. These regions may be country specific, state specific, or specific to any other suitable region. The subscriber may also select a metric in metric selector 432. The subscriber may also have the option to filter out data that is unactionable (e.g., data from unspecified regions). As an example and not by way of limitation, a subscriber Becky may wish to view the performance of her online advertising campaign for dresses from a geography-based perspective. Becky may select dresses in the campaign selector panel, select to view GOOGLE search results, and select all devices. Becky may also select state as the region level to view, and may select cost per acquisition (CPA) as her metric. The cost per acquisition may indicate the amount of money Becky spends to acquire one new customer. When Becky selects the “update” button or some similar button, geography-based visualization 400 may update to display the data according to Becky's specifications. By looking at geography-based visualization 400, Becky may notice that the CPA in California is 645, but the CPA in Georgia is only 610.50. To maximize her sales, it may be desirable for Becky to spend most of her advertising budget where it is most effective. In this scenario, Georgia's CPA is lower than California's CPA; thus, Becky's advertising dollars are more effective in Georgia than in California. Therefore, Becky may decide to move some of her advertising budget from California to Georgia. One way to do this is by increasing bid amounts in Georgia so that her ad rank improves.

In particular embodiments, advertising-analytics service 150 may enable map 410 to be interactive. Alternatively, it may provide a second visualization to aid in adjusting bid amounts for specific region. In particular embodiments, the second visualization may be interactive. As an example and not by way of limitation, the second visualization may be a bid modifying visualization, which may be displayed near geography-based visualization. Map 410 or the bid modifying visualization may include interactive elements that may be manipulated. The manipulation of the interactive elements may result from a user selecting an interactive element and manipulating it in some way. As an example and not by way of limitation, geography bubbles 411 may be interactive elements. Becky may select one of the geography bubbles 411 and perform various manipulations on it, including but not limited to, copy it, paste it, enlarge it, shrink it, drag it, darken or lighten its color, etc. Each manipulation may have a different effect on the online advertising campaign. In particular embodiments, each manipulation may have a different effect on the particular bid amounts associated with each particular geographic region. For example, copying a geography bubble 411 may have the effect of copying the bid amount associated with its particular geographic region. For example, if Becky is satisfied with a particular bid amount and wants to apply that bid amount to other locations, she may copy that geography bubble 411 and paste it in other geographic locations. As another example, Becky may wish to enlarge the area affected by a particular bid amount, so she may select the geographic bubble 411 associated with the area affected by the particular bid amount, and perform any suitable manipulation to enlarge it. Enlarging geographic bubble 411 may have the effect of enlarging the geographic area affected by the particular bid amount. Thus, the particular bid amount may be applied to a larger geographic area. As another example, Becky may wish to increase a bid amount for a particular geographic area. To do this, she may select the geographic bubble 411 associated with the particular geographic area. Geographic bubble 411 may have a degree of color or a degree of shading. The degree of color or shading may correspond with the bid amount. For example, a color of light green on geographic bubble 411 may correspond with a relatively low bid amount. To increase the bid amount, Becky may perform any suitable manipulation to darken geographic bubble 411. The effect of darkening geographic bubble 411 may be to increase the bid amount associated with the geographic region covered by geographic bubble 411. This disclosure contemplates any suitable manipulation of interactive elements included on map 410 or on the bid modifying visualization.

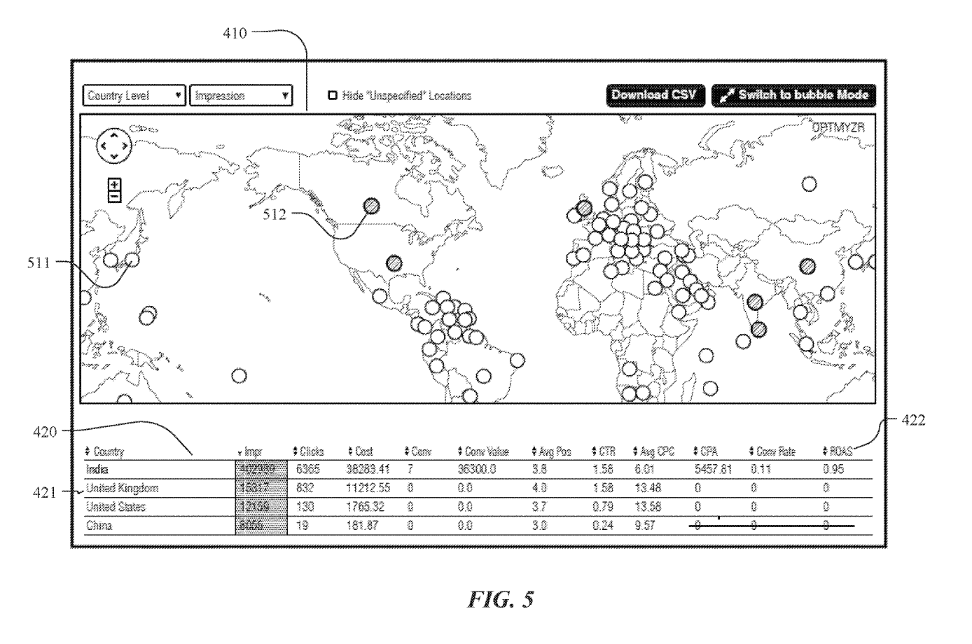

FIG. 5 illustrates another example geography-based visualization of an online advertising campaign provided by an advertising-analytics service. If the subscriber selects button 433, “Switch to non-bubble Mode,” map 410 may switch to non-bubble mode. In non-bubble mode, map 410 may include dots 511 and 512 instead of geographic bubbles 411. Dots 511 and 512 may belong to different groups, and may have distinguishing characteristics so that they are easily distinguished from one another. In particular embodiments, dot 511 may be associated with a group of geographic regions that are performing better than average. Dot 512 may be associated with a group of geographic regions that are performing worse than average. Table 421 may be similarly marked with distinguishing features (e.g., regions 421 may be colored or shaded to reflect the colors or shadings of dots 511 and 512). Metrics 422 associated with the online advertising campaign. The values under each metric may be the data associated with each metric for a particular region 421.

In particular embodiments, advertising-analytics service 150 may make at least pat of the geography-based visualization interactive. In particular embodiments, the subscriber may be able to select an automatic optimization, where advertising-analytics service 150 has calculated one or more bid adjustments to make based on the performance of particular geographic regions as compared to the average. As an example and not by way of limitation, advertising-analytics service 150 may determine that the United Kingdom has a much higher than average conversion rate and the United States has lower than average conversion rate, even though each region has comparable impression share. Advertising-analytics service 150 may determine to move some of the subscriber's advertising budget from the United States and into the United Kingdom, because that is where the impressions are most valuable. In particular embodiments, Advertising-analytics service 150 may present this optimization recommendation to the subscriber in the form of a “one-click optimization.” A one-click optimization may be a recommendation to alter the bid amounts for a particular advertising campaign in a particular way. To implement the recommendation, the subscriber need only to select the button or icon associated with the recommendation. Analytics-advertising service 150 may automatically update the online advertising campaign without any additional input from the subscriber.

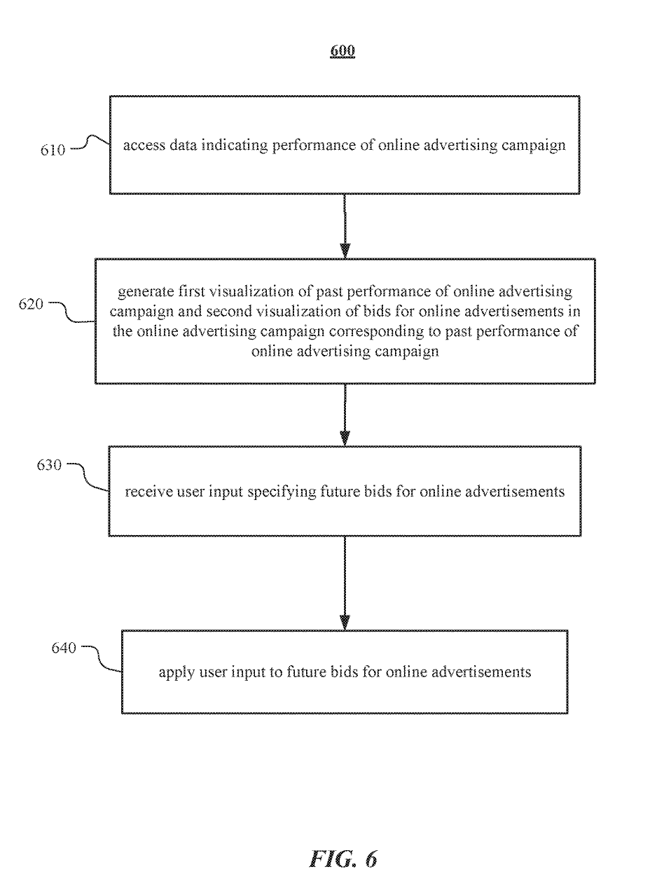

FIG. 6 illustrates an example method 600 for providing visualizations of an online advertising campaign. The method may begin at step 610, where one or more computing devices access data indicating past performance of an online advertising campaign with respect to one or more online-advertising metrics. As an example and not by way of limitation, the computing devices may be operated by advertising-analytics service 150. Web search engine 140 may gather and maintain the data, which originates from users 130 who perform web searches on web search engine 140. The data may indicate keyword search queries, clicks to particular links, conversions, or any other relevant metric.

At step 620, one or more computing devices generate a first visualization of the past performance of the online advertising campaign as a function of an independent variable and a second visualization of past bid adjustments for online advertisements in the online advertising campaign corresponding to the past performance of the online advertising campaign as a function of the independent variable. In particular embodiments, the independent variable is time-of-day, time-of-week, time-of-month, time-of-year, or other suitable independent variable. In particular embodiments, the independent variable is geographic area. In particular embodiments, the independent variable may be a key-performance-indicator (KPI) cluster. A KPI is a type of performance measurement. A KPI may report on the success or lack of success of an online advertising campaign. A KPI cluster may include two or more KPIs. A subscriber may choose its own KPI cluster. In addition or as an alternative, advertising-analytics service 150 may provide the KPI cluster for the subscriber. Example KPIs include new customer acquisitions, conversion rate, AD RANK, and cost per acquisition.

In particular embodiments, the independent variable may be search-query keyword(s). If the independent variable is search-query keyword(s), the first visualization may be a word cloud. The words in the word cloud may take different sizes and have different colors, patterns, or shading. The different sizes may indicate how many times that word is being searched by users of web search engine 140. A larger word has been searched more times on web search engine 140 than a smaller word. The color, pattern, or shading of the word may indicate a second set of data, (e.g., the metric specified the subscriber). The color, shading, or pattern may indicate the value of the second set of data as it applies to the particular word (e.g., the darker the shading the higher the value associated with that metric). As an example and not by way of limitation, a first word in the word cloud may be “pillows.” The subscriber may select clicks as the metric to view. The word “pillows” may be relatively large in the word cloud, indicating that the “pillows” keyword is being searched often. However, “pillows” may have a relatively light shading, indicating that not many users 130 are clicking on the pillows keyword. The subscriber may interact with the words in the word cloud to increase bid amount. For example, a subscriber may manipulate the appearance of a word to give it a darker shading. This may serve to instruct the advertising-analytics service 150 to increase the bid amount for that particular keyword.

In particular embodiments, an online-advertising metric may be number of impressions, impression share, number of clicks, average cost per click, click-through rate, cost, average position, conversion value, conversion value divided by cost, conversion value per click, converted clicks, cost per conversion click, cost per acquisition, conversion rate, number of conversions, or any other suitable online-advertising metric.

At step 630, one or more computing devices may receive user input from a user specifying future bid adjustments for online advertisements in the online advertising campaign relative to the past bid adjustments as a function of the independent variable. As an example, a subscriber Becky may be viewing a time-based visualization similar to metrics visualization 220. Becky may interact with a second visualization similar to bid modifying visualization 230. The user input may be Becky making changes to bid modifying visualization 230 by moving individual bid modifiers 232 up or down. In addition or as an alternative, advertising-analytics service 150 may provide recommended modifications according to one or more algorithms developed and implemented by advertising-analytics service 150. In particular embodiments these recommended bid modification may result from imitating one or more metrics, as discussed above. As an example, if conversion rate spikes on Tuesdays and Thursdays at 3:00 PM, advertising-analytics service 150 may automatically recognize this via peak-detecting software, and may provide a recommendation to Becky that she increase her bid amounts by 20% on Tuesdays and Thursdays from 1:00 PM to 5:00 PM. Becky may accept these recommendations with a single click to indicate acceptance (e.g., through a one-click optimization). Alternatively, Becky may adjust these bid modifications by adjusting the aggressiveness, baseline, and minimum/maximum bid amounts in dialogue box 340, as discussed above. This may also apply to a geography-based visualization, as discussed above with regard to FIGS. 4 and 5.

At step 640, one or more computing devices may apply the user input to future bid adjustments for online advertisements in the online advertising campaign relative to the past bid adjustments as a function of the independent variable. In particular embodiments, the method may further comprise automatically indicating for the user, based on the past performance of the online advertising campaign with respect to the online-advertising metric, future bid adjustments for online advertisements in the online advertising campaign relative to the past bid adjustments as a function of the independent variable; and the user input comprises a selection by the user of one or more of the future bid adjustments as indicated.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for providing visualizations of an online advertising campaign including the particular steps of the method of FIG. 6, this disclosure contemplates any suitable method for providing visualizations of an online advertising campaign including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

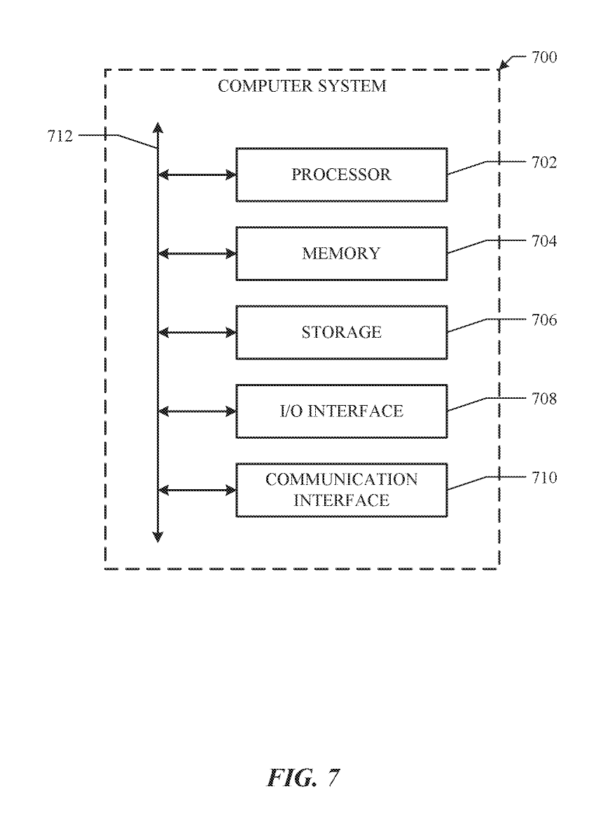

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

1. A method comprising:
by one or more computing devices, accessing data indicating past performance of an online advertising campaign with respect to one or more online-advertising metrics;
by one or more computing devices, generating:
a first visualization of the past performance of the online advertising campaign as a function of an independent variable; and
a second visualization of past bids or bid adjustments for online advertisements in the online advertising campaign corresponding to the past performance of the online advertising campaign as a function of the independent variable;
by one or more computing devices, receiving user input from a user specifying future bid adjustments for online advertisements in the online advertising campaign relative to the past bids or bid adjustments as a function of the independent variable; and
by one or more computing devices, applying the user input to future bid adjustments for online advertisements in the online advertising campaign relative to the past bids or bid adjustments as a function of the independent variable.

2. The method of claim 1, wherein:
the method further comprises automatically indicating for the user, based on the past performance of the online advertising campaign with respect to the online-advertising metric, future bid adjustments for online advertisements in the online advertising campaign relative to the past bids or bid adjustments as a function of the independent variable; and
the user input comprises a selection by the user of one or more of the future bid adjustments as indicated.

3. The method of claim of 1, wherein the independent variable comprises:
time-of-day;
time-of-week;
time-of-month; or
time-of-year.

4. The method of claim 3, wherein the one or more online-advertising metrics comprise:
number of impressions;
impression share;
number of clicks;
average cost per click;
click-through rate;
cost;
average position;
conversion value;
conversion value divided by cost;
conversion value per click;
converted clicks;
cost per conversion click;
cost per acquisition;
conversion rate; or
number of conversions.

5. The method of claim of 1, wherein the independent variable comprises geographic area.

6. The method of claim of 1, wherein the independent variable comprises a key-performance-indicator (KPI) cluster.

7. The method of claim of 1, wherein the independent variable comprises keywords in search queries.

8. One or more computer-readable non-transitory storage media embodying software that is operable when executed to:
access data indicating past performance of an online advertising campaign with respect to one or more online-advertising metrics;
generate:
a first visualization of the past performance of the online advertising campaign as a function of an independent variable; and
a second visualization of past bids or bid adjustments for online advertisements in the online advertising campaign corresponding to the past performance of the online advertising campaign as a function of the independent variable;
receive user input from a user specifying future bid adjustments for online advertisements in the online advertising campaign relative to the past bids or bid adjustments as a function of the independent variable; and
apply the user input to future bid adjustments for online advertisements in the online advertising campaign relative to the past bids or bid adjustments as a function of the independent variable.

9. The media of claim 8, wherein:
the media further comprises automatically indicating for the user, based on the past performance of the online advertising campaign with respect to the online-advertising metric, future bid adjustments for online advertisements in the online advertising campaign relative to the past bids or bid adjustments as a function of the independent variable; and
the user input comprises a selection by the user of one or more of the future bid adjustments as indicated.

10. The media of claim 8, wherein the independent variable comprises:
time-of-day;
time-of-week;
time-of-month; or
time-of-year.

11. The media of claim 10, wherein the one or more online-advertising metrics comprise:
number of impressions;
impression share;
number of clicks;
average cost per click;
click-through rate;
cost;
average position;
conversion value;
conversion value divided by cost;
conversion value per click;
converted clicks;
cost per conversion click;
cost per acquisition;
conversion rate; or
number of conversions.

12. The media of claim 8, wherein the independent variable comprises geographic area.

13. The media of claim of 8, wherein the independent variable comprises a key-performance-indicator (KPI) cluster.

14. The media of claim of 8, wherein the independent variable comprises keywords in search queries.

15. A system comprising: one or more processors; and a memory coupled to the processors comprising instructions executable by the processors, the processors being operable when executing the instructions to:
access data indicating past performance of an online advertising campaign with respect to one or more online-advertising metrics;
generate:
a first visualization of the past performance of the online advertising campaign as a function of an independent variable; and
a second visualization of past bids or bid adjustments for online advertisements in the online advertising campaign corresponding to the past performance of the online advertising campaign as a function of the independent variable;
receive user input from a user specifying future bid adjustments for online advertisements in the online advertising campaign relative to the past bids or bid adjustments as a function of the independent variable; and
apply the user input to future bid adjustments for online advertisements in the online advertising campaign relative to the past bids or bid adjustments as a function of the independent variable.

16. The system of claim 15, wherein:
the media further comprises automatically indicating for the user, based on the past performance of the online advertising campaign with respect to the online-advertising metric, future bid adjustments for online advertisements in the online advertising campaign relative to the past bids or bid adjustments as a function of the independent variable; and
the user input comprises a selection by the user of one or more of the future bid adjustments as indicated.

17. The system of claim 15, wherein the independent variable comprises:
time-of-day;
time-of-week;
time-of-month; or
time-of-year.

18. The system of claim 17, wherein the one or more online-advertising metrics comprise:
number of impressions;
impression share;
number of clicks;
average cost per click;
click-through rate;
cost;
average position;
conversion value;
conversion value divided by cost;
conversion value per click;
converted clicks;
cost per conversion click;
cost per acquisition;
conversion rate; or
number of conversions.

19. The system of claim 15, wherein the independent variable comprises geographic area.

20. The system of claim of 15, wherein the independent variable comprises a key-performance-indicator (KPI) cluster.
